(19) United States
(12) Patent Application Publication
(10) Pub. No.: US 2006/0224769 A1
(43) Pub. Date: Oct. 5, 2006

(54) Method and transmitter for transmitting data packets

(76) Inventor: Benny Moonen, Koersel (BE)

Correspondence Address: MORRISON & FOERSTER LLP, 1650 TYSONS BOULEVARD, SUITE 300, MCLEAN, VA, 22102, US

(21) Appl. No.: 10/549,896

(22) PCT Filed: Feb. 9, 2004
(86) PCT No.: PCT/EP04/01176

§ 371 Date: Sep. 20, 2005

(30) Foreign Application Priority Data
Mar. 20, 2003 (EP) 03006392.9

(51) Int. Cl. G06F 15/173

(52) U.S. Cl. 709/238

(57) ABSTRACT

The invention relates to a method for transmitting a series of user data packets from a transmitter to a receiver using a TCP protocol. A first number of user data packets in the series is transmitted to the receiver in sequence during the transmission of several user data packets. Subsequently, the transmitter transmits a second number of user data packets to the receiver, and the transmitter receives a confirmation of receipt from the receiver upon receipt of the first number of user data packets. The timing of the subsequent transmission is determined so that transmission occurs before receipt of the confirmation by the transmitter of the user data packets. The invention also relates to a device comprising elements for carrying out the method on the transmitter side.

### CLAIM FOR PRIORITY

This application is a national stage of PCT/EP2004/001176, published in the German language on Feb. 9, 2004, which claims the benefit of priority to European Application No. 03006392.2, which was filed in the German language on Mar. 20, 2003, the contents of which are hereby incorporated by reference.

### TECHNICAL FIELD OF THE INVENTION

The invention relates to a method and device for transmitting a series of user data packets, and in particular, from a transmitter in some instances via one or more devices that route the user data packets to a receiver using a TCP protocol.

### BACKGROUND OF THE INVENTION

In radio communication systems information (for example voice, image information, video information, SMS (short message service) or other user data) is transmitted with the aid of electromagnetic waves via a radio interface between the transmitting radio station and the receiver. The electromagnetic waves are thereby emitted at carrier frequencies that are within the frequency band provided for the respective system. A radio communication system hereby comprises subscriber stations, e.g. mobile stations, base stations, and other network-side devices.

In many radio communication systems, e.g. in systems according to the GPRS (General Packet Radio Service) standard, as in many line-based networks, user data is transmitted in blocks from a transmitter to a receiver in the form of user data packets. The TCP (transmission control protocol) protocol is often deployed for this purpose, being generally also used for data transmissions relating to the internet. At the start of a user data transmission using the TCP protocol the so-called slow-start algorithm is thereby deployed to avoid overloading the respective network. To this end the transmitter first transmits one or a few user data packets. Once the transmitter has received confirmation of receipt for this or these user data packet(s), it transmits a larger number of data packets. As a result the data rate transmitted between the transmitter and receiver is increased over time. A description of the slow-start algorithm can be found for example in W. Richard Stevens: TCP/IP Illustrated, volume 1, The Protocols, Addison Wesley Longman, Inc., 1994, pages 285-287.

### SUMMARY OF THE INVENTION

The invention relates to a method for transmitting a series of user data packets from a transmitter in some instances via one or more devices that route the user data packets to a receiver using a TCP protocol.

The invention also relates to a device for transmitting a series of user data packets to a receiver in some instances via one or more devices that route the user data packets.

In one embodiment of the invention, there is a method which allows the efficient transmission of user data packets between a transmitter and a receiver in the initial phase of the transmission of user data between the transmitter and receiver. An appropriate device for transmitting user data packets of the type mentioned above is also to be highlighted for this purpose.

A TCP protocol is used to transmit a series of user data packets from a transmitter in some instances via one or more devices that route the user data packets to a receiver. At the start of the user data transmission, the transmitter transmits a first number of user data packets from the series of user data packets to the receiver. If this first number of user data packets comprises a plurality of user data packets, these are transmitted directly one after the other. The transmitter transmits no user data packets to the receiver for a time period after transmitting the first number of user data packets. At a later time the transmitter transmits a second number of user data packets from the series of user data packets to the receiver. The transmitter receives a confirmation of receipt from the receiver, which the receiver transmits on receipt of the first number of user data packets.

According to one aspect of the invention, the later time is defined such that it is before the time of receipt of the confirmation of receipt by the transmitter of the user data packets.

The TCP protocol used in the invention for the transmission of data packets is a reliable protocol, which can be deployed to transport data in a reliable fashion through various networks. In particular the TCP is deployed in conjunction with the IP protocol (internet protocol). In the OSI layer model the TCP protocol is on the fourth layer, i.e. the transport layer, while within the TCP/IP layer model it is on the third layer, i.e. the transport layer or host-to-host layer.

With the method the transmitter has user data which is to be transmitted to the receiver in the form of a plurality of user data packets. The transmission can either take place directly, i.e. without further intermediate devices, between the transmitter and the receiver, for example via fixed lines or by radio, or the user data packets can be routed via one or more devices between the transmitter and receiver. The user data transmission starts with the transmitter transmitting a first number of user data packets to the receiver. The user data packets in the first number of user data packets are hereby transmitted as directly as possible one after the other. The time between transmission of the individual user data packets of the first number of user data packets is a function of the capacity of the transmitter. A delay can hereby occur as a result of the packets having to be generated or processed in the transmitter in the various logical layers of the transmitter.

After transmitting the first number of user data packets, the transmitter transmits no further user data packets to the receiver for a time period. During this time period the receiver waits in respect of the transmission of user data to the receiver. This waiting time period in any case exceeds the time period that elapses in some instances between transmission of the individual user data packets of the first number of user data packets. At a later time the transmitter transmits a second number of user data packets to the receiver. As with the first number of user data packets, this can be a single user data packet or a plurality of user data packets. The later time relates to the transmission of the first user data packet transmitted from the second number of user data packets.

The transmitter receives a confirmation of receipt from the receiver, which the receiver transmits on receipt of the first number of user data packets. The transmitter can therefore conclude from this confirmation of receipt that the receiver has received the first number of user data packets and therefore in this instance there has been no loss of some of the first number of user data packets or even all the user data packets of the first number of user data packets. The transmitter starts to transmit the second number of user data packets before it receives the confirmation of receipt from the receiver for the first number of user data packets. The time period during which the transmitter transmits no user data packets to the receiver is therefore limited in an upward direction by this condition.

In another aspect of the invention, the later time is defined such that the receiver receives the second number of user data packets after transmitting the confirmation of receipt. This has the advantage that standard methods, e.g. the known slow-start algorithm, in which the receiver receives a second number of user data packets after transmitting the confirmation of receipt for the first number of user data packets, is modified to a limited degree, in order to be able to implement the method according to the invention. With this development of the invention no change is therefore required on the receiver side in respect of the the standard methods. A change would however be necessary for the receiver, if the later time were defined such that the receiver receives the second number of user data packets before transmitting the confirmation of receipt, which corresponds to another embodiment of the method according to the invention.

The time period is advantageously a function of the time difference between transmission of a data packet by the transmitter and receipt of the data packet by the receiver. The time difference between transmission of a data packet by the transmitter and receipt of said data packet by the receiver generally corresponds to the time difference between transmission of a data packet by the receiver and receipt of the data packet by the transmitter, so the functional relationship can also be formulated conversely. According to the above embodiments the functional relationship of the time period impacts directly on the definition of the later time, at which the second number of user data packets is transmitted, as the later time represents the end of the time period. Such a time difference can in particular be determined before transmission of the user data packets, e.g. in the context of a connection set-up routine. To this end the time from transmission of a data packet by the transmitter to receipt of a data packet functioning as a response to the data packet in the transmitter can be measured to determine the round trip time. The time difference between transmission of a data packet by the transmitter and receipt of said data packet by the receiver is approximately half this round trip time. The time period during which the transmitter transmits no user data packets to the receiver may for example correspond to the determined half round trip time or even a fraction or multiple of said half round trip time.

In one embodiment of the invention, the user data packets are transmitted from the transmitter to the receiver at least to some degree by radio. The radio communication standard GPRS or UMTS for example can be used for this purpose. The user data packets can hereby be transmitted directly by radio from the transmitter to the receiver but it is also possible for the user data packets to be transmitted from the transmitter via a fixed line to a device, which transmits the user data packets by radio to the receiver. Further intermediate devices can also be used to route the user data packets.

The user data packets are preferably data from the internet.

In another embodiment of the invention, the receiver is part of a mobile radio communication system. The transmitter also represents a device connected both to the mobile radio communication system and to a different network using a TCP protocol. An example of such a receiver is a mobile station of a GPRS radio communication system, an example of a transmitter according to the invention is a TCP proxy, which functions as a link between the GPRS radio communication system and the internet.

It is possible for the second number of user data packets to exceed the first number of user data packets. This is particularly advantageous when the method according to the invention is a reworked slow-start algorithm.

The device for transmitting a series of user data packets to a receiver in some instances via one or more devices that route the user data packets has means for using a TCP protocol to transmit user data packets and means for transmitting a first number of user data packets from the series of user data packets to the receiver, during transmission of a plurality of user data packets as the first number of user data packets directly one after the other, also means for transmitting a second number of user data packets from the series of user data packets to the receiver at a later time after a time period after transmission of the first number of user data packets.

According to one aspect of the invention, the device has means for defining the later time, such that the later time is before the time of receipt of a confirmation of receipt transmitted by the receiver on receipt of the first number of user data packets in the device.

The device according to the invention is particularly suitable for implementing the method according to the invention. It may have further means for this purpose.

In another embodiment of the invention, the device has means for defining the later time, such that the time period is a function of the time difference between transmission of a data packet by the device and receipt of said data packet by the receiver.

In still another embodiment of the invention, the device is connected to a mobile radio communication system such that the user data packets can be transmitted to the receiver via the mobile radio communication system.

### BRIEF DESCRIPTION OF THE DRAWINGS

The invention is described in more detail below with reference to exemplary embodiments and the illustrations, in which:

FIG. 1 shows a GPRS radio communication system connected to the internet.

FIG. 2 shows a flow diagram according to the prior art.

FIG. 3 shows a flow diagram according to the invention.

FIG. 4 shows a transmitter according to the invention.

### DETAILED DESCRIPTION OF THE INVENTION

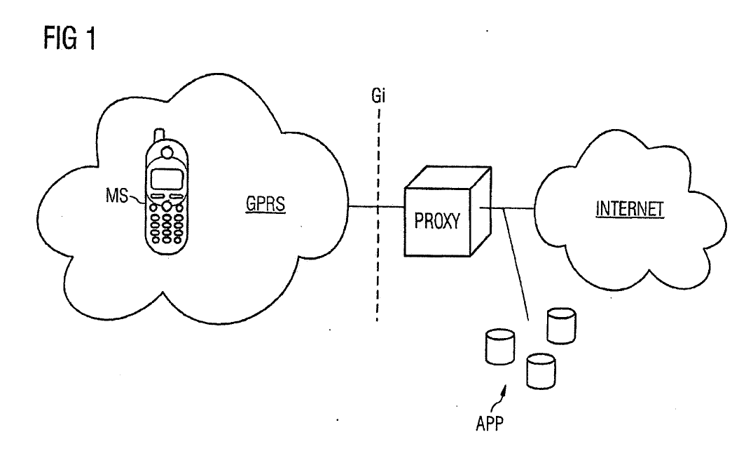

FIG. 1 shows a mobile radio communication system GPRS according to the GPRS standard, within which user data can be transmitted in packets. The invention can however also be applied to other mobile radio systems, e.g. systems according to the UMTS standard. A mobile station MS is part of the mobile radio communication system GPRS. A mobile radio subscriber wishes to download data from the internet INTERNET via the mobile station MS. To this end the mobile radio communication system GPRS is connected to the internet INTERNET via a proxy server PROXY. Various applications APP, e.g. e-mail, information services, games, various downloads, as well as video and audio services, are available. The proxy server PROXY is located at the Gi interface Gi of the mobile radio communication system GPRS. This interface represents the reference point between the gateway GPRS support unit (GGSN) and the external IP network in the form of the internet INTERNET. If a request is made for data from the internet within the radio communication system GPRS, said request is not transmitted directly to a server on the internet INTERNET but to the proxy server PROXY. This retrieves the requested web page from a web server on the internet INTERNET, downloads said page, stores it on a hard disk and then forwards the requested data to the subscriber station in the radio communication system GPRS, from which the request originated. The data may however not be stored by the proxy server PROXY, for example on instruction from the web server or based on the configuration.

User and signaling data is transmitted between the proxy server PROXY and the mobile station MS via a plurality of intermediate devices. To this end the proxy server PROXY is connected by lines to a device in the core network of the radio communication system GPRS, from which the information is transmitted via lines to base stations, from which the information is transmitted by radio to the mobile station MS.

User data packets are transmitted from the internet INTERNET via the proxy server PROXY to the mobile station MS using the transmission control protocol TCP. The transmission control protocol of the transport layer is deployed in conjunction with the internet protocol IP of the switching layer. TCP is a connection-oriented end-to-end protocol with secured data transmission, connection control, flow control, time monitoring and multiplex in the transport layer of the protocol architecture TCP/IP. TCP is therefore responsible for the correct delivery of data.

If user data is to be transmitted to a subscriber using the TCP, the so-called slow-start algorithm is used. This algorithm is intended to reduce the risk of overloading or congestion on a network. To this end the transmitter starts the transmission of user information by transmitting a few data packets, transmitting further data packets on receipt of a positive confirmation from the receiver of the data packets. A larger number of data packets can be transmitted from the transmitter to the receiver after every positive confirmation of the receipt of data packets from the receiver. This means that the transmitted data rate can be increased over time, until the current maximum possible data throughput is achieved.

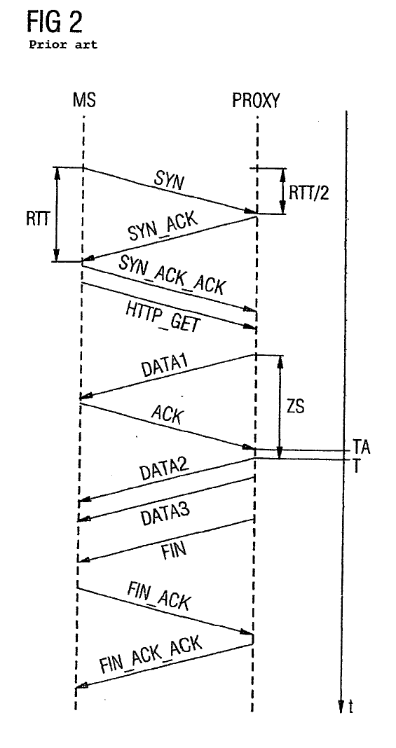

FIG. 2 shows a flow diagram for the use of a slow-start algorithm. The time t is plotted downwards in FIG. 2. In the example under consideration data packets are transmitted between the mobile station MS and the proxy server PROXY. As the TCP is a connection-oriented protocol, the connection between the mobile station MS and the proxy server PROXY is first set up via a 3-way handshake. This 3-way handshake allows control information to be exchanged to establish the logical end-to-end connection. To this end the mobile station MS first transmits a signaling packet SYN. The signaling packet SYN allows the mobile station MS to inform the proxy server PROXY for example that the mobile station MS wishes a connection to be set up. As confirmation the proxy server PROXY transmits a signaling packet SYN_ACK. The mobile station MS again confirms this signal with a signaling packet SYN_ACK_ACK. The mobile station MS also transmits a signaling packet HTTP_GET to the proxy server PROXY, containing the specific request for data packets from the internet.

The time between transmission of the signal SYN by the mobile station MS and receipt of the signal SYN-ACK is for example referred to as the round trip time RTT. The time difference RTT/2 between transmission of a data packet and receipt of the same data packet corresponds approximately, apart from delays which may occur due to the processing and generation or handling of data packets, to half the round trip time RTT. During the connection set-up routine the round trip time RTT and/or the time difference between transmission and receipt of a signal between the transmitter and receiver is/are determined by the proxy server PROXY.

Once the connection has been set up between the mobile station MS and the proxy server PROXY, due to the request from the mobile station MS for data from the internet, on receipt of the data requested by the mobile station MS in the proxy server PROXY, a data set for the mobile station MS is present in the proxy server PROXY. This data is handled by the proxy server PROXY according to the TCP protocol and transmitted to the mobile station MS. In the example under consideration it is assumed that three user data packets with data from the internet are to be transmitted to the mobile station MS. The proxy server PROXY first transmits a first user data packet DATAL from the set of data requested by the mobile station MS to the mobile station MS. When the mobile station MS receives the user data packet DATA1, it transmits a confirmation of receipt ACK to the proxy server PROXY. After the confirmation of receipt ACK has been received in the proxy server PROXY at time TA, said proxy server PROXY transmits two further user data packets DATA2 and DATA3 at time T to the mobile station MS. The time period ZS runs from transmission of the first user data packet DATAL to transmission of the second user data packet DATA2 and the proxy server PROXY waits during this period, i.e. it transmits no data packets to the mobile station MS.

According to the slow-start algorithm the proxy server PROXY is authorized to transmit further user data packets to the mobile station MS, when a positive confirmation of receipt ACK of the first user data packet has been received. This means that the time TA is before the time T according to the flow diagram in FIG. 2.

The connection between the mobile station MS and the proxy server PROXY is canceled after user data packet transmission has been terminated using signaling data packets FIN, FIN_ACK and FIN_ACK_ACK in a similar fashion to the handshake during connection set-up. The signaling FIN can hereby also be transmitted in conjunction with the user data packet DATA3.

While confirmation signaling in the form of the data packets SYN_ACK_ACK, FIN_ACK_ACK and ACK has different names in the context of the example described, its set-up and action are generally identical when TCP is used.

The size of objects downloaded from the internet is generally approximately 10 KB. This corresponds to around 7 to 8 user data packets within the GPRS radio communication system. This small number of user data packets means that the majority of the user data packets is transmitted using the slow-start algorithm. In this phase, during which the slow-start algorithm is applied, the achievable transmission rate is significantly lower than the maximum achievable transmission rate based on the bandwidth available within the GPRS radio communication system.

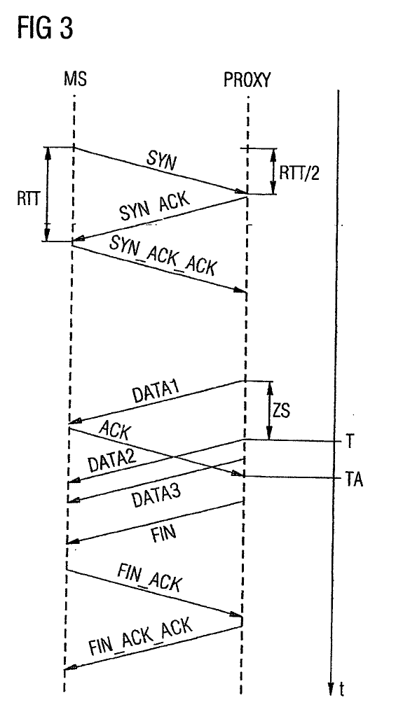

FIG. 3 shows a flow diagram of a method according to the invention. Again three user data packets from the internet are to be transmitted via the proxy server PROXY to the mobile station MS. The connection between the proxy server PROXY and the mobile station MS is set up in a similar fashion to the flow diagram in FIG. 2.

The user data transmission between the proxy server PROXY and the mobile station MS is started by the proxy server PROXY transmitting a first user data packet DATAL to the mobile station MS. On receipt of this first user data packet DATAL the mobile station MS transmits a positive confirmation of receipt ACK, which the proxy server PROXY receives at time TA. During the time period ZS the proxy server PROXY transmits no user data packets to the mobile station MS. The proxy server PROXY does not wait until it receives the confirmation of receipt ACK at time TA to transmit the further user data packets DATA2 and DATA3. At the end of the time period ZS, at the time T, which is before the time TA of receipt of the confirmation of receipt ACK in the proxy server PROXY, the proxy server PROXY starts to transmit the remaining user data packets DATA2 and DATA3.

Different delay times can result in each instance between receipt of a data packet and transmission of a data packet in response to the received data packet and these are a function of the capacities of the transmitter or receiver. For example delays result from the handling of the received signals and generation of the signals to be transmitted. One example of such a delay can be seen between transmission of the user data packet DATA2 and the user data packet DATA3. However in the method according to the invention the time period ZS is in any case greater than the delay times resulting from the processing capacities of the transmitter.

The connection between the proxy server PROXY and the mobile station MS is canceled in a similar fashion to the flow diagram in FIG. 2.

The time period ZS between transmission of the first user data packet DATA1 and transmission of the further user data packets DATA2 and DATA3 is defined by the proxy server PROXY. This corresponds directly to a definition of the transmission time T of the user data packets DATA2 and DATA3. This time period ZS can be a function in particular of the result determined previously for the round trip time RTT. For example ZS can be defined such that it corresponds to approximately half RTT/2 the round trip time RTT.

One advantage of the method according to the invention is that user data packets to be transmitted can be transmitted at the start of the user data transmission in a shorter time than would be possible using the conventional slow-start algorithm. This is achieved by reducing the time, during which both the mobile station MS and the proxy server PROXY wait in a ready to receive state, i.e. the time after transmission of the confirmation of receipt by the receiver until transmission of the further data packets by the transmitter at time T.

In contrast to the transmission of user data packets via fixed lines, the proportion of user data packets lost during radio transmission using GPRS is small. If a user data packet is lost, the proxy server PROXY cannot receive a confirmation of receipt ACK, as the receiver does not transmit such a confirmation. In this instance the user data packet in question that was lost during transmission is retransmitted. The low packet loss rate within a GPRS radio communication system means that such a failure to receive a confirmation of receipt ACK occurs rarely. The method according to the invention, in which the transmitter does not wait until it receives the confirmation of receipt ACK before transmitting further user data packets, can therefore be applied particularly advantageously to mobile radio communication systems.

Application of the method according to the invention to a mobile radio communication system is also particularly advantageous, as the round trip time in the mobile radio communication system is generally very long. Round trip times of 1.5 seconds between the Gi interface and a mobile station are therefore standard. This means that, if an unmodified slow-start algorithm is used, a long time elapses between receipt of the first data packet and the next data packet in the mobile station. This has the result that in the initial phase of a user data transmission only a few user data packets can be transmitted each time. By reducing the time period between transmission of a first user data packet and the next user data packet in the context of a modified slow-start algorithm, the method according to the invention allows a significant increase to be achieved in the data throughput at the start of a user data transmission.

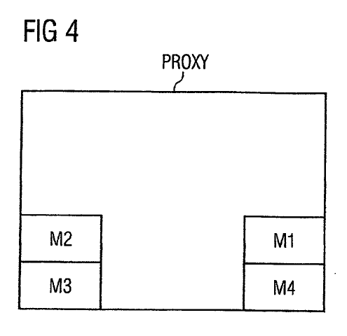

FIG. 4 shows a transmitter according to the invention in the form of a proxy server PROXY. This has means M1, which allow it to receive, handle and transmit data packets using the TCP protocol. Means M2 and M3 are also available, which the proxy server PROXY can use to transmit user data packets to a receiver according to the method according to the invention. The means M4 allow the transmitter to define a time at which it transmits further user data packets, after waiting for a time period after transmission of a first or a number of first user data packets, without transmitting user data packets to the receiver.

Modification of the slow-start algorithm for transmitting data from a proxy server to a subscriber station here is independent of the use of the slow-start algorithm for transmitting data between the internet and the proxy server. The protocol stack of the proxy server can therefore be modified on the subscriber station side, in order to be able to implement the method according to the invention, without requiring modification of the protocol stack on the internet side.

The method according to the invention requires no modification of the subscriber station, which receives the data from the transmitter. Rather the subscriber station can respond as required by the conventional slow-start method.

1. A method for transmitting a series of user data packets from a transmitter to a receiver using a TCP protocol, comprising:
transmitting, at the start of the user data transmission, a first number of user data packets from the series of user data packets to the receiver;
transmitting, during transmission of a plurality of user data packets, the user data packets directly one after the other as the first number of user data packets, and not transmitting user data packets to the receiver for a time period after transmitting the first number of user data packets;
transmitting a second number of user data packets from the series of user data packets to the receiver at a later time; and
receiving a confirmation of receipt transmitted on receipt of the first number of user data packets from the receiver, wherein
the later time is defined such that it is before a time of receipt of the confirmation of receipt by the transmitter of the user data packets.

2. The method according to claim 1, wherein the later time is defined such that the receiver receives the second number of user data packets after transmitting the confirmation of receipt.

3. The method according to claim 1, wherein the time period is a function of a time difference between transmission of a data packet by the transmitter and receipt of the data packet by the receiver.

4. The method according to claim 1, wherein the user data packets are transmitted by the transmitter to the receiver at least to some degree by radio.

5. The method according to claim 1, wherein the user data packets are data from the internet.

6. The method according to claim 1, wherein
the receiver is part of a mobile radio communication system, and
the transmitter is a device connected both to the mobile radio communication system and another network using a TCP protocol.

7. The method according to claim 1, wherein the second number of user data packets exceeds the first number of user data packets.

8. A device for transmitting a series of user data packets to a receiver comprising:
a first unit for using a TCP protocol to transmit user data packets;
a second unit for transmitting a first number of user data packets from the series of user data packets to the receiver, during transmission of a plurality of user data packets directly one after the other as the first number of user data packets; and
a third unit for transmitting a second number of user data packets from the series of user data packets to the receiver at a later time after a time period after transmitting the first number of user data packets, wherein
the device has a fourth unit for defining the later time, such that the later time is before a time of receipt of a confirmation of receipt transmitted by the receiver on receipt of the first number of user data packets in the device.

9. The device according to claim 8, wherein the time period is a function of a time between transmission of a data packet by the device and receipt of said data packet by the receiver.

10. The device according to claim 8, wherein the device is connected to a mobile radio communication system such that the user data packets can be transmitted via the mobile radio communication system to the receiver.
